(19) United States
(12) Patent Application Publication
(10) Pub. No.: US 2002/0197146 A1
(43) Pub. Date: Dec. 26, 2002

(54) Packaging and materials handling method for heavy rolls of paper

(76) Inventors: Philip Rolfe, St. Louis, MO (US); Robert G. Snyder, Lockport, IL (US)

Correspondence Address: LEON I EDELSON, LAW OFFICE OF LEON I EDELSON, PO BOX 2465, CHICAGO, IL, 60690-2465, US

(21) Appl. No.: 09/887,650

(22) Filed: Jun. 21, 2001

(51) Int. Cl. B65F 9/00

(52) U.S. Cl. 414/809

(57) ABSTRACT

This invention pertains to a packaging and materials handling procedure for heavy rolls of paper and the related means comprising an assembly of devices consisting of end cap support assemblies and a roll ramp, and alternatively, a wheeled barrow.

### FIELD OF INVENTION

This invention pertains to a packaging and materials handling method for heavy rolls of paper wherein the packaging method facilitates the materials handling of heavy rolls of paper by one or two persons and protects the rolls of paper from dirt, contamination, and undesirable flattening of the circumference of the paper rolls during movement and storage times if the rolls are rolled or laid upon their sides. The instant invention accordingly pertains to a procedure and related means comprising an assembly of devices for packaging and materials handling of heavy rolls of paper.

### BACKGROUND OF THE INVENTION

Paper mills produce paper in large rolls, which are utilized by paper converters to prepare smaller rolls, for direct utilization by printers and manufacturer of paper products such as paper sheets and other forms of paper. The large paper rolls from the paper mills, which paper rolls can weigh 4000 pounds and be up to 50 inches in diameter and 55 inches in length, are converted into smaller rolls of perhaps 175 to 200 pounds in weight and 20 to 24 inches in length and up to about 20 inches in diameter. Paper converters are defined as manufacturers engaged in converting raw paper stock from paper mills into semi-finished products suitable for further processing by printers and paper product manufacturers of articles such as stationery. Customers of paper converters can be small business operations of one or two employees with limited facilities for handling heavy rolls of paper. Physical limitations of the business operators, such as printers and paper product manufacturers with one or two employees, in the absence of mechanical devices, preclude ready movement of the heavy cylindrical rolls of paper received from the paper converter.

It is also understood by those in the print paper trade and also by paper products manufacturers in such as the paper stationery trade that there is annually a loss in connection with paper rolls due to the crushing of the edges of the paper when the roll is tilted during handling. Much of the roll paper, especially that intended for printing and stationery uses, is comparatively thin and tender and the edge of the paper crushes when the roll is tilted up on edge as is possible during loading upon a shipping pallet. Roll paper products of a paper converter are shipped to customers by freight forwarders on shipping pallets, the paper rolls stacked vertically upon the pallets, or laid upon their sides.

The object of the instant invention is to provide a simple and efficient means for protecting the paper roll edges and a simple means for handling the heavy paper rolls by one or two persons wherein the means of protecting the paper roll edges from damage, in combination with a means for materials handling of the paper roll, permits one or two persons to efficiently and safely handle and position the heavy paper rolls in a small print shop or paper product manufacturer as required without doing any damage to the paper.

### DESCRIPTION OF THE PRIOR ART

Methods and apparatus for moving heavy rolls, coils, reels or spools of products such as paper, foil, textiles, sheet metal, etc., frequently require intervention of some type of powered lifting apparatus. Many such rolls of products weight from 500 to 10,000 pounds and cannot be lifted or maneuvered manually.

A number of power lifting devices and related structures are known. U.S. Pat. No. 5,253,972 teaches and claims a specially constructed pallet jack for transporting a heavy roll of paper having a central hollow core. The pallet jack includes a frame with elongated arms having first and second ends, with a first set of wheels mounted at the second end of the arms and a second set of wheels mounted near the first end of the arms. Between the elongated arms is provided a cradle into which a heavy paper roll is rolled. The cradle pivots when the paper roll is rolled into the cradle. The elongated arms of the frame are provided with a jack to jack up the front end of the arms of the frame to allow the resulting dolly to wheel the paper roll to a desired position. Lowering the arms of the frame to the floor allows the roll to be removed. U.S. Pat. 5,820,330 teaches and claims an apparatus for receiving and transporting reels of packaging material such as paper, foil and the like received upon a pallet and resting horizontally next to one another upon the pallet. The apparatus comprises a manually operated device with four rollers on an undercarriage. Two parallel projecting arms extend to form a U-shaped frame to pick up the reels to be removed from the pallet and transported. The arms are positioned apart to be spaced under the roll and to lift the roll by a hydraulic mechanism actuated manually by the operator. U.S. Pat. No. 5,009,563 discloses and claims a mobile vehicle for handling heavy cylindrical paper rolls, which comprises a roll support cradle formed by diverging opposite elongated leaves, which can be raised or lowered to tilt the cradle and allow the paper roll to roll from the cradle. The mobile vehicle carries the paper roll from a warehousing location and delivers the roll to point of use. The rolling technique is presented as advantageous in moving rolls without intervention of forklift carriers or other devices.

Other power lifting devices are known which provide a probe for insertion into an externally accessible axial opening of an object to be moved to lift, maneuver and support the object. U.S. Pat. Nos. 4,358,143 and 4,687,244 each teaches a roll lift and transfer apparatus, which insert a center probe into a roll of paper or other material and allow lifting and re-orienting the roll as required. A movable overhead crane can support the device. U.S. Pat. No. 5,688,098 teaches a transfer system including a roll holder having an upright member with a support member extending outward from the upright member in a cantilevered fashion. The cantilevered arm lifts the roll by insertion through the roll of material and allows the roll to be moved and maneuvered.

Accordingly, it is well known to use power lifting devices to move heavy rolls of materials such as paper because of the weight and size of the rolls, but for users of rolls of material without the availability of power lifting devices, the problem of lifting and maneuvering such rolls or paper can require equipment that can be expensive, awkward to handle, complex in operation, and not manually operated.

As already noted, the handling of rolls of paper can result in loss of paper on the rolls of paper due to the crushing of the edges of the paper when the roll is tilted during handling and the roll rests upon the edge of the roll. As indicated, much of the roll paper used for printing is comparatively thin and tender and the edge of the paper roll is easily crushed when the roll is tilted up on edge in moving it in or out of freight carriers or in preparing the roll to place the roll in a printing press or stationery manufacturing equipment. Additionally, if the paper roll is laid flat upon a support surface for storage, the roll can be permanently flattened in its circumference and lead to undesirable processing problems of the paper roll in further processing. Further, protection of the ends of the paper roll from dirt and contamination during handling prior to further processing of the roll in printing and machine operations upon the roll is advantageous as such protection reduces loss of paper from such causes.

### SUMMARY OF THE INVENTION

The instant invention provides a packaging and materials handling method and means for handling heavy rolls of paper by manual procedures by one or two persons without use of power equipment. The invented method utilizes two novel end cap support assemblies and a roll ramp. The end cap support assemblies have center probes for insertion into externally accessible axial openings of the paper roll. One end cap support assembly is placed upon the each end of the roll, each end cap support assembly in circumference greater than the circumference of the roll, thus permitting the paper roll to roll upon the circumference of the end cap support assemblies in the method of a wheeled object.

The end cap support assemblies are placed upon the roll by the paper converter as packaging equipment to protect the paper roll during shipment and handling. The end cap support assemblies are removed as required by rolling the end cap support assembly paper roll onto a cradle roll ramp of shorter width than the paper roll length and thus freeing the end cap support assemblies for removal. The paper roll is moved from the cradle roll ramp by picking up the paper roll with a suitable dolly or small barrow such as a hand truck for transport to a desired location. Alternatively, the dolly or borrow can be used to remove the end cap support assemblies by supporting the end cap support assembly paper roll during the removal.

### DESCRIPTION OF THE PREFERRED EMBODIMENT

The packaging and materials handling method of the instant invention requires as essential elements:

A) Two end cap support assemblies, each end-cap support assembly comprising (a) a circular disc of pressed wood or a suitable plastic designated as a wheel and (b) an annular open-ended member of suitable plastic designated as a core plug. Each core plug is flanged at one end. Each core plug is inserted through the said circular disc wherein the flanged element engages and mates with said circular disc. The two circular discs in combination with said annular open-ended member core plugs serving as a support for said paper rolls, the core plugs serving as an axle for the paper roll.

B) The circular discs are of a diameter larger than the roll of paper and thus the circular discs can serve as wheels for the paper roll. The annular open-ended members inserted through the axial openings of the circular discs are inserted into the externally accessible axial openings of the paper roll to serve as a shaft for rotation of the paper roll.

C) a roll ramp comprising three inclined levels, a first level comprising an entry level, the second and third levels comprising a cradle formed by the declined second level and the inclined third level.

D) Alternatively, a hand dolly or wheeled barrow to support the wheeled paper roll to remove the two end cap support assemblies instead of a roll ramp.

In operation, the paper converter converts paper rolls as received from paper mills in the form of large rolls to smaller rolls suitable for use by printers and stationery manufacturers. The product of the paper converter accordingly is a smaller paper roll of up to about 200 pounds or more and of length up to about six feet or more. The paper converter places the end cap support assemblys upon each end of the produced paper roll, inserting the core plug of each end cap support assembly into the externally accessible axial opening of the paper roll. The circular disc support wheels on each end of the paper roll protect the ends of the paper roll from being crushed or otherwise damaged during movement and prevent flattening of the paper roll when rolled or laid upon its side. The wheeled paper roll is wheeled onto the roll ramp by an operator to permit the end cap support assemblys to be removed. One person can load the paper roll into a printing press or paper-manufacturing machine with a suitable hand truck or dolly. The hand truck or dolly can also be used to support the wheeled paper roll to remove the end cap support assemblies from the paper roll.

### BRIEF DESCRIPTION OF THE DRAWINGS

FIG. 1 is a perspective view of two end cap support assemblies placed upon a paper roll, illustrating the insertion of the core plugs into externally accessible axial openings of the paper roll.

FIG. 2 is a perspective view of the end cap support assembly illustrating the insertion of the core plugs into the axial openings of the circular discs. The outer flange at one end of the core plug seats in position on the outer surface of the circular disc, the projecting collar of the core plug extending through the circular disc to form an end cap support assembly.

FIG. 3 is a perspective view of the roll ramp, in position to receive a paper roll, which is rolled up the beginning incline and over a supporting inclined edge into a cradle formed by two inclined surfaces.

FIG. 4 is a perspective view of a paper roll supported in the cradle of the roll ramp with the end caps of the support assemblies projecting over the sides of the roll ramp to allow easy removal of the end cap support assemblies from the paper roll by the operator.

FIG. 5 is a perspective view of the end cap support assemblies mounted upon a paper roll, the paper roll positioned on the roll ramp to permit removal of the end cap support assemblies.

### DETAILED DESCRIPTION OF THE DRAWINGS

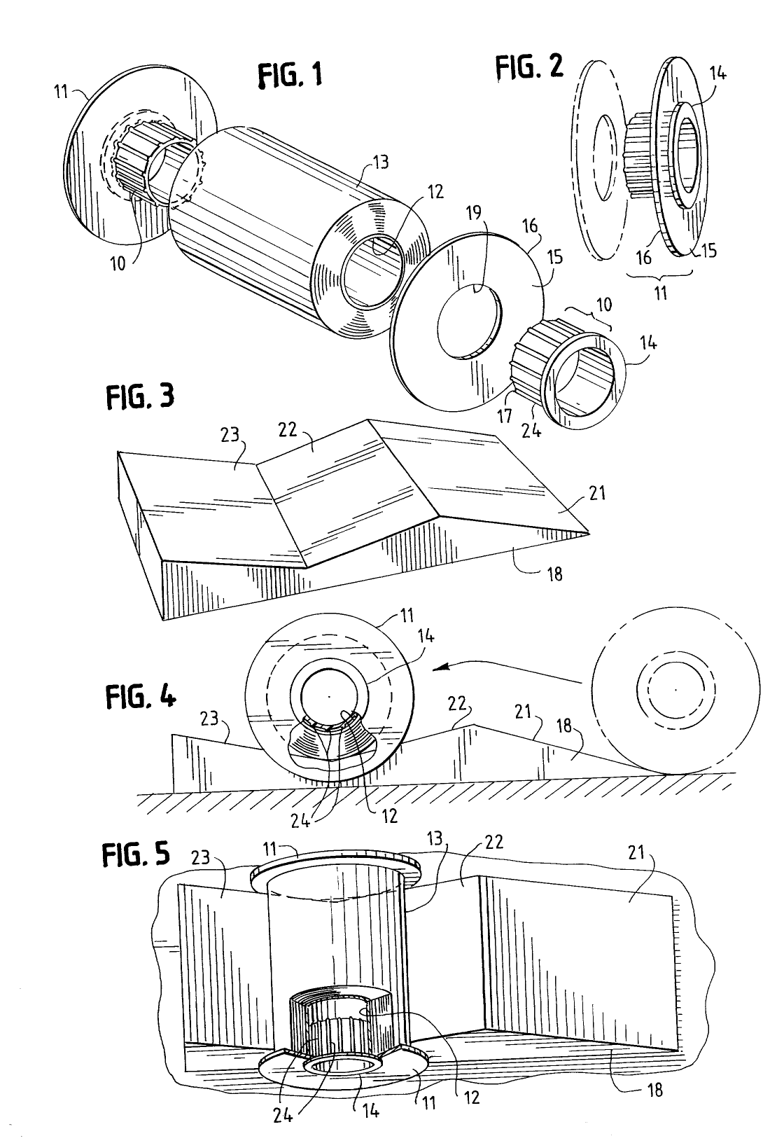

Upon inspection of FIG. 1, it will be noted that the projecting collars 17 of the core plugs 10 of each end cap support assembly 11 are inserted into the axial annular openings 12 of the paper roll 13, the projecting collars 17 of core plugs 10 being sized to fit snugly within the openings 19. The dimensions of the projecting collar 17 of the core plug 10 are sized as required by the dimensions of the paper roll annular openings 12. The outer core diameter of the projecting collar 17 of the core plug 10 is dimensioned to form a snug fit with the annular core 12 of the paper roll 13.

The flange 14 of the core plug 10 seats snugly against the outer surface 15 of the circular disc 16, the core plug 10 and associated circular disc 16 comprising an end cap support assembly 11. The core plug 10 is held in position on the circular disc 16 by the tubular structure of the projecting collar 17 of the core plug 10 inserted through circular disc 16 through opening 19. The friction fit of the projecting collar 17 within the circular disc 16 serves to maintain the projecting collar 17 in position on the circular disc 16. Once the two end cap support assembly members, collectively termed “end cap support assemblies,” are placed upon the paper roll 13, one end cap support member assembly 11 upon each end, the paper roll 13 can be wheeled to whatever location is needed by a single operator.

Each end cap support assembly upon each end of the paper roll effectively protects the roll paper ends during movement of the paper roll. The end cap support assemblies are removed from the paper roll by wheeling the wheeled paper roll onto the roll ramp 18. The end cap support assemblies are removed by the single operator. The core shaft from the printer can be inserted through the axial annular openings of the paper roll. The paper roll is removed by a single operator from the roll ramp and transported to a printing press or manufacturing equipment with a suitable hand dolly, hand truck or small wheeled barrow. Alternatively, the single operator can use a suitable hand dolly or small wheeled barrow to raise the paper roll with the installed end caps support assemblies from the supporting surface to remove the installed end cap support assemblies from the paper roll.

The circular disc 16 of the end cap support assembly 11 can be any suitable material with necessary physical characteristics. Preferably, the circular disc 16 is prepared form a pressed-wood stock of suitable dimensions. The outer diameter of the disc 16 is necessarily greater than the diameter of the paper roll 13 and thus serves as a wheel. The circular disc 16 is fitted with an annular opening 19 to insert the core plug 10, the annular opening 19 of the circular disc sized to provide a force fit of the core plug 10 in the annular opening 19.

The core plug is preferably of a suitable plastic material such as polyethylene, polypropylene, polyurethane, polyacrylate, etc. As already described, the core plug is shaped with the tubular structure of projecting collar 17 projecting through the circular disc wheel 16, one end of the tubular structure of projecting collar 17 with flange 14 to retain the core plug 10 in position on the circular disc 16. The projecting collar 17 can have an external series of grooves or ridges 24 to improve holding power.

The roll ramp is preferably of a suitable plastic such as polyethylene, polypropylene, polyurethane, polyacrylate, etc. The width of the ramp is less than the length of the paper roll so that the disks of the end cap support assemblies project over the edges of the roll ramp. Easy removal of the end cap support assemblies is thus permitted. The roll ramp comprises three connected sloping surfaces wherein first connecting surface 21 inclines moderately upward from a first level to a height sufficient to connect to second connecting downward sloping surface 22 which slopes to a second low level above the lowest first level of first connecting surface 21 and high enough to raise the end cap support assemblies above the supporting floor. The second connecting downward sloping surface 22 connects to third connecting surface 23 at the second low level of the second connecting downward sloping surface 22 to form a rising support surface for the cylindrical paper roll positioned between the two sloping surfaces of the ramp structure to comprise a holding cavity or cradle for the paper roll 13. The degree of incline of the three supporting surfaces can be what is convenient for the operator, consistent with the size and weight of the paper roll. In practice, the roll ramp is suitably sized to accept the paper roll and thereby cause the paper roll and end cap support assemblies to be raised from the support surface upon being wheeled onto the roll ramp.

What is claimed is:

1. A packaging and materials handling procedure for one person to manually handle and maneuver cylindrical rolls of paper comprising the steps of:
a) Individually placing on each end of each paper roll an end cap support assembly which supports the paper roll from contact with any support surface and protects the paper roll ends from dirt, contamination and being crushed, to form a mobile unit and
b) wheeling each said cylindrical roll of paper supported by said two end cap support assemblies, one on each end of said roll to comprise a mobile unit, to a roll ramp to position said mobile unit in the cradle of said roll ramp, said cradle of sufficient height above a supporting surface to raise said end cap support assemblies from said support surface,
c) manually removing said end cap support assemblies from ends of said paper roll,
d) manually positioning said paper roll on a barrow to move the paper roll to a desired location.

2. The packaging and materials handling procedure of claim 1 wherein said end cap support assembly comprises:
a) A circular disc of diameter greater than the diameter of the said paper roll, said circular disc with a center annular opening to receive an annular open-ended core plug support member;
b) an open-ended core plug support member defined as a tubular structure having an outer flange around one end to mate with said circular disc upon insertion through annular opening of said circular disc.

3. The packaging and materials handling procedure of claim 1 wherein said roll ramp comprises three connecting sloping surfaces wherein a first connecting surface inclines upward from a first level to a height sufficient to connect with a second connecting surface inclining downward to connect with a third connecting surface inclining upward, the conjoining second and third connecting surfaces forming a cradle for support of said paper roll with said end cap support assemblies placed thereon, said cradle of said roll ramp supporting said discs of said end cap support assemblies above any support surface.

4. The circular disc of claim 2 wherein said center annular opening is grooved.

5. The tubular structure of said open-ended core plug of claim 2 wherein said tubular structure has an external series of grooves to improve holding power within said annular opening of said circular disc.

6. The tubular structure of said open-ended core plug of claim 2 wherein said tubular structure has external ridges to improve holding power within said annular opening of said circular disc.

7. The packaging and materials handling procedure of claim 1 for one person to manually handle and maneuver cylindrical rolls of paper which comprises a means to support said paper roll consisting of an end cap support assembly on each end to form a mobile unit and a removal means to remove said paper roll said end cap support assembly from each end of said paper roll said removal means comprising a roll ramp of three connecting sloping surfaces of which two surfaces form a cradle for said paper roll and the third surface inclines upward to connect to the two surfaces forming said cradle and, alternatively, a suitable wheeled barrow.
